(19) United States
(12) Patent Application Publication
(10) Pub. No.: US 2011/0283546 A1
(43) Pub. Date: Nov. 24, 2011

(54) Circular Blade Cutting Tool

(75) Inventors: Gustavo A. Abreu, Sao Paulo (BR); Thiago P. Manacorda, Sao Caetano do Sul (BR)

(73) Assignee: GM GLOBAL TECHNOLOGY OPERATIONS, INC., DETROIT, MI (US)

(21) Appl. No.: 12/782,043

(22) Filed: May 18, 2010

(51) Int. Cl. B26B 25/00; B26B 5/00

(52) U.S. Cl. 30/278; 30/289

(57) ABSTRACT

A cutting tool comprising a main body, a blade shield, a support arm and a circular blade. The main body includes a first guide surface along an edge of the main body and a first blade slot recessed in the main body and opening to the first guide surface. The blade shield has a second guide surface extending generally parallel to and in spaced relation to the first guide surface to define a gap therebetween, with the blade shield also having a second blade slot recessed in the blade shield and opening to the second guide surface. The support arm is secured to the main body and the blade shield to hold the main body and the blade shield in spaced relation. The circular blade is removably secured in the first blade slot and extends through the gap into the second blade slot.

### BACKGROUND OF INVENTION

The present invention relates generally to a hand operated cutting tool.

When handling significant amounts of materials arriving at or passing through a factory, warehouse, distribution or shipping center, many times this involves the use of box cutters to cut the cardboard or plastic straps off of the products being shipped. The sharp blades of the box cutters are exposed, which leads to some workers cutting their hands with the blades while opening the boxes. To minimize this, some try to always cut away from themselves, but this is not always the easiest and fastest way to open the boxes.

### SUMMARY OF INVENTION

An embodiment contemplates a cutting tool comprising a main body, a blade shield, a support arm and a circular blade. The main body includes a first guide surface along an edge of the main body and a first blade slot recessed in the main body and opening to the first guide surface. The blade shield has a second guide surface extending generally parallel to and in spaced relation to the first guide surface to define a gap therebetween, with the blade shield also having a second blade slot recessed in the blade shield and opening to the second guide surface. The support arm is secured to the main body and the blade shield to hold the main body and the blade shield in spaced relation. The circular blade is removably secured in the first blade slot and extends through the gap into the second blade slot.

An advantage of an embodiment is that the cutting tool can be employed to cut various materials, such as, for example, cardboard boxes and shipping straps, while minimizing the potential for a person operating the cutting tool to cut himself. The person operating the tool can cut toward or away from himself without the concern of being cut by the blade, thus allowing for increased speed in opening boxes or cutting objects when using this tool.

### BRIEF DESCRIPTION OF DRAWINGS

FIG. 1 is a perspective view of a cutting tool.

FIG. 2 is a different perspective view of the cutting tool.

FIG. 3 is an other perspective view of the cutting tool.

FIG. 4 is a side view of the cutting tool.

FIG. 5 is a side view of a circular blade used in the cutting tool.

### DETAILED DESCRIPTION

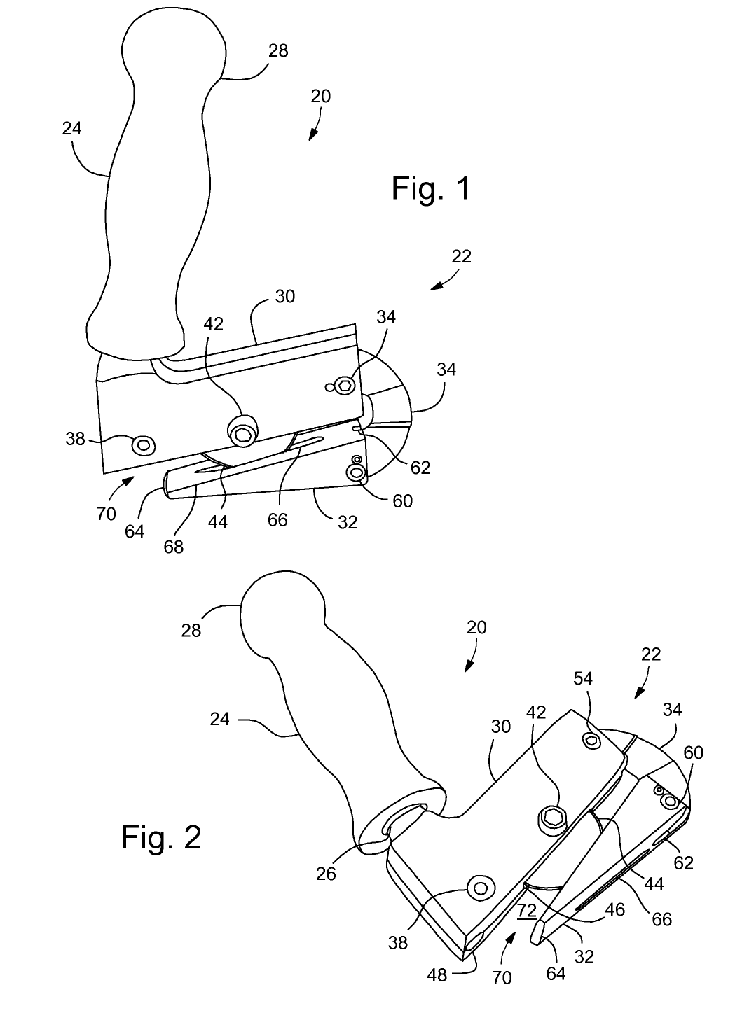

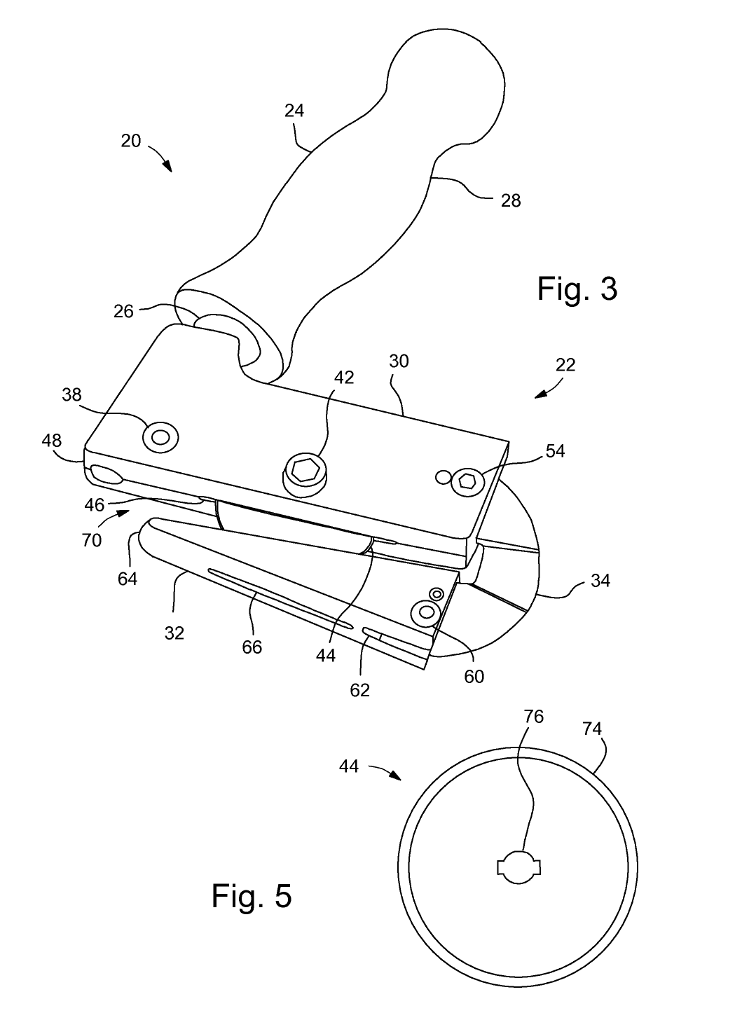

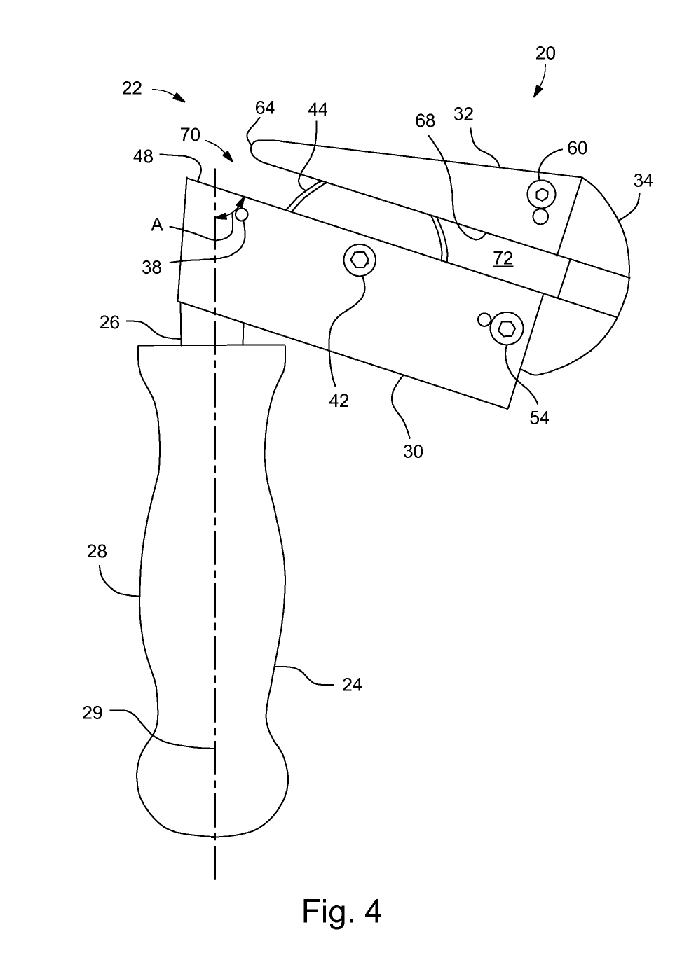

Referring to FIGS. 1-5, a cutting tool 20, and portions thereof, are shown. The cutting tool 20 includes a cutting head assembly 22 with a handle 24 extending away from the assembly 22. The handle 24 may include a shaft 26, which may be made of a metal such as steel or aluminum, with a covering 28, which may be made of rubber or plastic, that is shaped to allow one to easily grip the handle 24 with one's hand. A handle longitudinal axis 29 (shown in FIG. 4) may be at an angle A of about seventy two degrees relative to the cutting head assembly 22 for ease in operator control of the cutting tool 20. However, other angles of handle to cutting head may be employed instead if so desired.

The cutting head assembly 22 may include a main body 30, a tapered blade shield 32 and a support arm 34. The main body 30 may be formed in two halves and include four bores extending through it. The first bore may receive a fastener 38 that holds the two halves of the main body 30 together near the front of the body. The second bore may receive a second fastener 42 that supports a circular blade 44 within a slotted cavity 46 that opens to a first guide surface 48 along a bottom edge of the main body 30. The third bore and the fourth bore may include at least one fastener 54 to secure the support arm 34 between the two halves of the main body 30.

The support arm 34 may be generally U-shaped and extend from the back edge of the main body 30 to the back edge of the blade shield 32, holding the main body 30 and the blade shield 32 in spaced relationship to each other. First and second bores may extend through the blade shield 32, with at least one fastener 60 securing the support arm 34 within a slot 62 in the back edge of the blade shield 32.

The blade shield 32 may be generally triangular in shape, with a relatively narrow front edge 64 and tapering wider as it extends toward the back edge where the support arm 34 attaches. A blade slot 66 extends into a second guide surface 68 (and may extend all of the way through the blade shield 32), aligned with the circular blade 44 to allow the blade 44 to slide within the slot 66.

The first guide surface 48 and the second guide surface 68 may extend generally parallel to and be spaced apart from each other to form a gap 72. The gap 72 defines a material opening 70 at the shield front edge 64. The width of the gap 72 defines the maximum thickness of material that the cutting tool 20 will cut. The circular blade 44 preferably has a sharp edge 74 around its circumference and a hole 76 through its center that is used to secure it to the main body 30.

The operation of the cutting tool 20 will now be discussed. When one wishes to cut material, such as, for example, a top of a cardboard box or a shipping strap around a box, the opening 70 is aligned with an edge of the material to be cut. One grips the handle 24 and moves the cutting tool 20 so that the material is drawn into the gap 72 and into contact with the sharp edge 74 of the circular blade 44. The operator then pulls or pushes (as the case may be) on the handle 24, causing the material to be cut by the blade 44 as the material slides past the blade 44. The first guide surface 48 and the second guide surface 68 trap and guide the material as cutting occurs. The material, having been cut, can then slide out the back end of the gap 72 past the support arm 34.

During this cutting process, the operator is protected from the sharp edge 74 of the blade 44 by the main body 30 and especially by the blade shield 32. The narrow front edge 64 of the shield 32 still allows the blade shield to slip between two pieces of adjacent material when it is only desired to cut one of them. Moreover, when the sharp edge 74 of the blade 44 becomes dull, the blade 44 can be relatively easily removed and replaced with a new one.

While certain embodiments of the present invention have been described in detail, those familiar with the art to which this invention relates will recognize various alternative designs and embodiments for practicing the invention as defined by the following claims.

What is claimed is:

1. A cutting tool comprising:
a main body including a first guide surface extending along an edge of the main body and a first blade slot recessed in the main body and opening to the first guide surface;
a blade shield having a second guide surface extending generally parallel to and in spaced relation to the first guide surface to define a gap therebetween, the blade shield also having a second blade slot recessed in the blade shield and opening to the second guide surface;
a support arm secured to the main body and the blade shield to hold the main body and the blade shield in spaced relation; and
a circular blade removably secured in the first blade slot and extending through the gap into the second blade slot.

2. The cutting tool of claim 1 including a handle configured for gripping by a human hand, secured to and extending from the main body.

3. The cutting tool of claim 2 wherein the blade shield is tapered, having a narrow front edge adjacent to a material opening portion of the gap and a relatively wider rear end adjacent to the support arm.

4. The cutting tool of claim 3 wherein the circular blade includes a sharp edge extending around a circumference of the blade.

5. The cutting tool of claim 1 wherein the blade shield is tapered, having a narrow front edge adjacent to a material opening portion of the gap and a relatively wider rear end adjacent to the support arm.

6. The cutting tool of claim 1 wherein the circular blade includes a sharp edge extending around a circumference of the blade.

7. The cutting tool of claim 1 including a handle configured for gripping by a human hand, secured to the main body and extending from the main body at an angle of approximately seventy two degrees from the first guide surface.

8. The cutting tool of claim 1 wherein the main body includes a first half releasably secured to a second half, with the circular blade secured between the first half and the second half.

9. A cutting tool comprising:
a main body including a first guide surface extending along an edge of the main body and a first blade slot recessed in the main body and opening to the first guide surface;
a handle configured for gripping by a human hand, secured to and extending from the main body;
a blade shield having a second guide surface facing and in spaced relation to the first guide surface to define a gap therebetween, the blade shield also having a second blade slot recessed in the blade shield and opening to the second guide surface;
a support arm secured to the main body and the blade shield to hold the main body and the blade shield in spaced relation; and
a circular blade removably secured in the first blade slot and extending through the gap into the second blade slot.

10. The cutting tool of claim 9 wherein the blade shield is tapered, having a narrow front edge adjacent to a material opening portion of the gap and a relatively wider rear end adjacent to the support arm.

11. The cutting tool of claim 9 wherein the circular blade includes a sharp edge extending around a circumference of the blade.

12. The cutting tool of claim 1 wherein the main body includes a first half releasably secured to a second half, with the circular blade releasably secured between the first half and the second half.
